(19) United States
(12) Patent Application Publication
(10) Pub. No.: US 2016/0292807 A1
(43) Pub. Date: Oct. 6, 2016

(54) System and Method for Selecting a Physician and Other Professional Service Providers

(71) Applicant: Siobhan O'Grady, Oyster Bay, NY (US)

(72) Inventor: Siobhan O'Grady, Oyster Bay, NY (US)

(21) Appl. No.: 14/715,564

(22) Filed: May 18, 2015

Related U.S. Application Data
(60) Provisional application No. 61/994,952, filed on May 18, 2014.

(51) Int. Cl. G06Q 50/22; G06Q 10/06; G06F 17/30; G06F 17/27

(52) U.S. Cl. CPC G06Q 50/22; G06F 17/2705; G06Q 10/06398; G06F 17/3089; G06F 17/30377

(57) ABSTRACT

The invention is a method for selecting a professional service provider, the steps including visiting a web page that has implemented provider reviews; updating a div on the web page; making a request to an RSS feed for provider information; parsing the information, and generating XML related to an RSS specification.

### FIELD OF THE INVENTION

This invention relates to a system and method of selecting a medical practitioner, or other professional, from among a plurality of physicians or other professionals, the selection process based on inputs provided by patients of the physicians.

### BACKGROUND OF THE INVENTION

When a prospective patient requires the services of a new physician, or another type of service professional, it may be a difficult process to select the appropriate health care provider in the absence of recommendations from other patients or clients. What is needed is a system and method of conveniently sharing experiences and ratings for a physician's or other service professional, among the physician's patients or among the professional's clients.

It is thus an objective of the present invention to provide an App for installation on a tablet device, for example, such as in an office review system, or at an office kiosk, that allows the patient to select the healthcare provider just recently seen and, while still in the office, review the physician or service provider after the appointment. The reviews are then sent to a specified database which creates an RSS feed of the reviews to be displayed on the professional's personal website, Facebook pages, findatopdoc.com, and/or other similar web sites across the Internet.

### BRIEF DESCRIPTION OF THE DRAWINGS

FIG. 1 is an illustration of a computer tablet provided for use at a physician's office, in accordance with an aspect of the present invention;

FIG. 2 is a screenshot of a Physician listing screen;

FIG. 3 is a screenshot of a Review page;

FIG. 4 is a screenshot of a Ratings page;

FIG. 5 is a screenshot of an Acknowledgement page;

FIG. 6 is a screenshot of an initial website page;

FIG. 7 is a screenshot of a System setup page;

FIG. 8 is a screenshot of an Add Doctor page;

FIG. 9 is a screenshot of a Physician Roster Edit page;

FIG. 10 is a screenshot of a system setup login page;

FIG. 11 is a screenshot of a Physician Roster page;

FIG. 12 is a screenshot of a Customer Login page;

FIG. 13 is a functional diagram of an information retrieval process, in accordance with the present invention; and

FIG. 14 is an illustration of a computer tablet kiosk provided for use at a professional's office, in accordance with an aspect of the present invention.

### DETAILED DESCRIPTION OF THE INVENTION

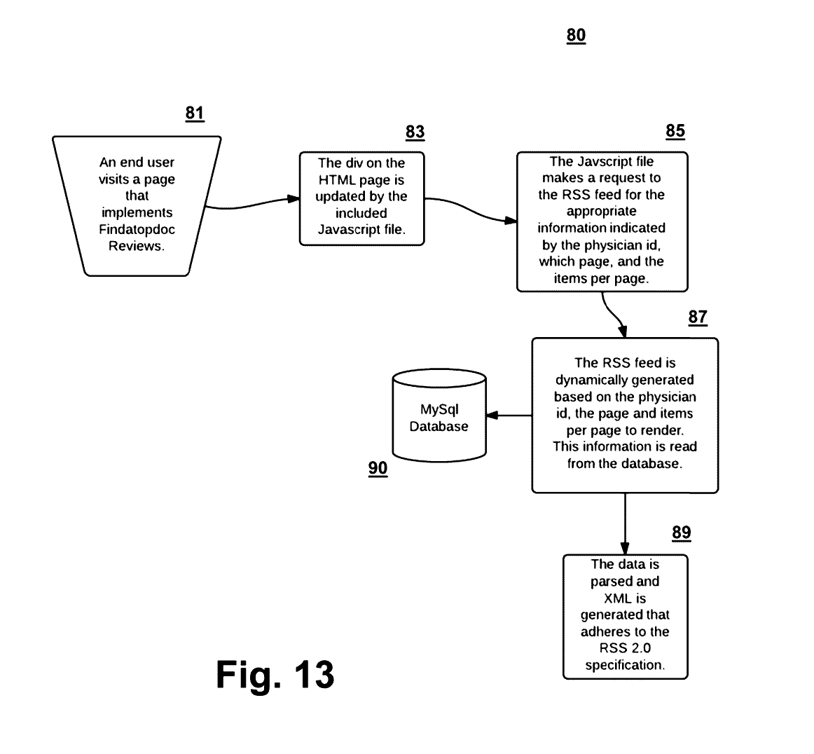

The present invention uses a system of communication devices, having “FindaTopDoc” App software therein, to offer information to clients related to services provided by a professional, such as a physician. In particular, as applied to the patients of a physician, the method of the present invention, enabled by the FindaTopDoc App software, functions to: (1) collect patient experiences and patient recommendations, before the patient leaves a physician's office, thus, obtaining information within a short time after the patient has completed an office visit with the physician, (2) transmit this information to a remote database, herein designated as a “FindaTopDoc” relational database 90, shown in FIGS. 13, and (3) share the database information with other prospective patients and with the attending doctor.

This information may be retrieved by the other patients as a means of assisting the patients in the selection of medical service providers. In particular, such information is typically of great value to another prospective patient as the patient's experiences and recommendations are recorded in “real time,” in the physician's office, and while the details of the office visit are still “fresh” in the patient's mind. In contrast, when a patient submits a response at a later time, via e-mail, a post card, or a follow-up phone call, for example, the response may be of lesser value as certain details of the office visit may have faded from the patient's memory.

Although the present specification discloses the invention as may be applied to a physician and the patients of the physician, it should be understood that the present invention is likewise applicable to other types of service providers that have waiting areas for clients, such as accountants, psychiatrists, chiropractors, financial advisors, government service providers, and attorneys, for example.

A plurality of communication devices having access to FindaTopDoc App software may be disposed at the office locations of medical service providers who have elected to be included in the FindaTopDoc relational database 90. The communication devices may be used for entering physician data by a patient immediately after an office visit, as well as for enabling a new patient to retrieve the physician data and comments prior to the office visit. This FindaTopDoc relational database 90 can be accessed through a FindaTopDoc website, using the same office communication devices, or can be accessed by a prospective patient's personal computer or mobile communication device before arriving at the physician's office.

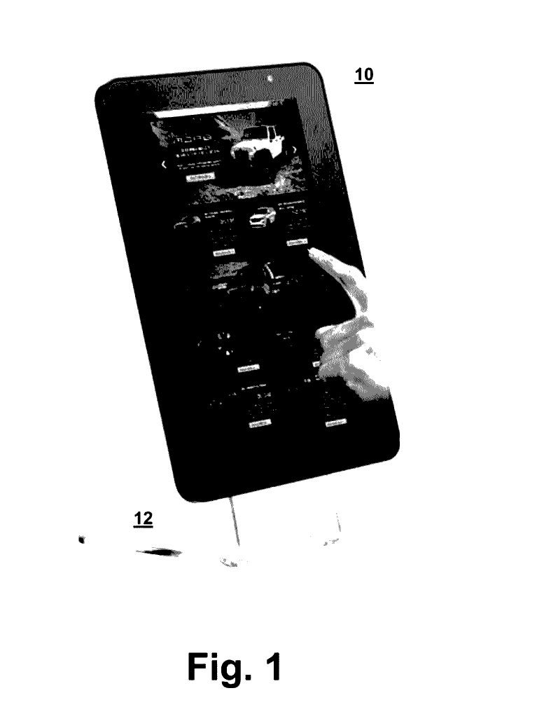

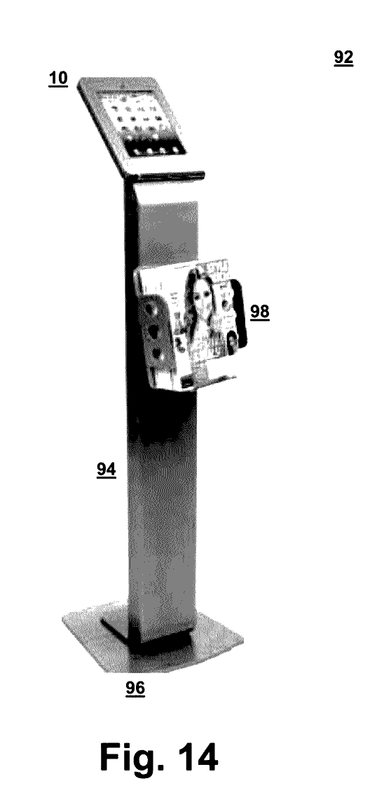

There is shown in FIG. 1 an office computer tablet 10, where the office computer tablet 10 includes the FindaTopDoc App software, and is secured to a stand 12 as may be provided in the seating area of a doctor's office or a service provider's waiting area. It should be understood that any communication device, such as a Smartphone or Personal Digital Assistant, can be interchanged with the office computer tablet 10, as long as the communication device can function to access the FindaTopDoc App software disclosed herein, and can provide and retrieve inputs to/from the FindaTopDoc relational database 90. The communication device provided may be disposed on a counter surface, as shown, or may be placed on a pedestal as shown in FIG. 14, or may be wall-mounted for the convenience of the patient.

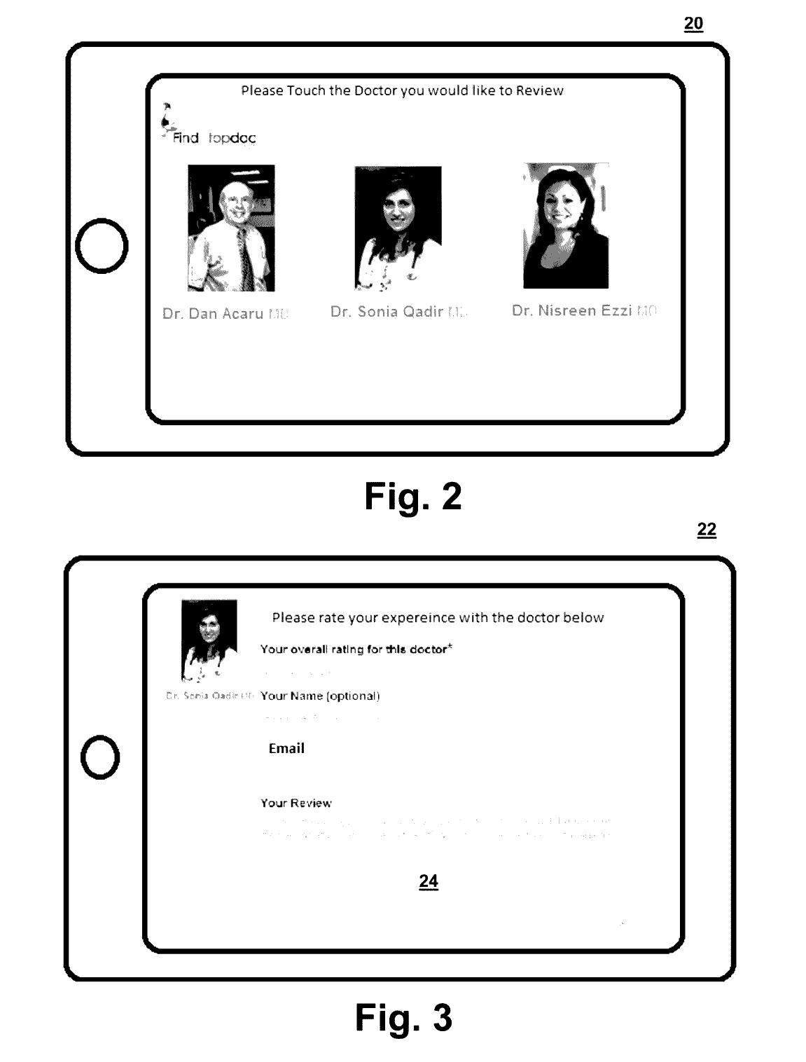

Upon completing a visit with the physician, the patient may access the office computer tablet 10 to input comments and recommendations by logging into a Physician Listing Screen 20 displayed by accessing the FindaTopDoc software, shown in FIG. 2. In the example provided, the office has listed three doctors who have agreed to participate in the patient review process. In an exemplary embodiment, the participating physician may also receive an RSS feed from the reviews being posted via the office computer tablet 10. The patient may be prompted to make a selection from the list of doctors provided on the display screen.

Upon making a selection via the Physician Listing Screen 20, the patient may be taken to a Review Page 22, shown in FIG. 3, for the selected doctor, where the name and e-mail of the patient may optionally be entered. A Review Field 24 is provided for answering questions about the office visit such as, for example: (1) what was most memorable? (2) what did you like or dislike? (3) what would you tell a friend? and (4) would you choose this doctor again?

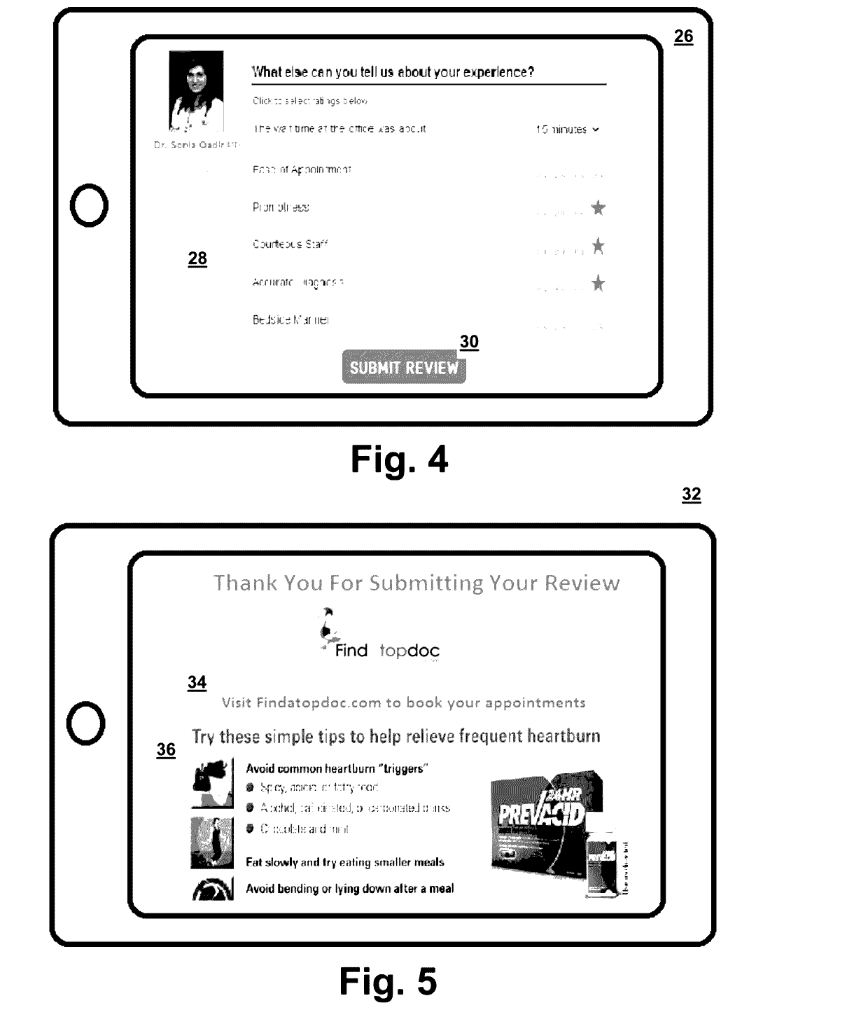

Upon submitting the data in the Review Page 22, the patient may be taken to a Ratings Page 26, shown in FIG. 4, where a list of office visit criteria 28 may be provided for the patient to tell others of the office visit experience. The office visit criteria 28 may include one or more of key phrases such as, for example: (1) length of wait time; (2) face of the visit; (3) promptness; (4) courteous staff; (5) accurate diagnosis; and (6) bedside manner. In the example provided, the patient may assign up to a “four star” rating for each of the office visit criteria 28. A “Submit Button” 30 may be provided for use by the patient to submit the review and to log out of the review process.

Upon exiting the Ratings Page 26, the office computer tablet 10 may display an Acknowledgement Page 32, shown in FIG. 5, informing the patient that the review has been submitted. There may be a message 34 suggesting to the patient that a specified website can be used to book another appointment. Additionally, the display screen may also include an advertisement 36 to inform the patient and possibly generate advertising revenue for the physician's office.

The above sequence of steps may be repeated by other patients, both current patients and prospective patients, in the doctor's office, for the selected doctor or for one of the other doctors listed on the Physician Listing Screen 20. The data entered in the Review Page 22 and the Ratings Page 26 may be stored in the FindaTopDoc relational database 90, which may be resident in a remote server (not shown), as is well-known in the art.

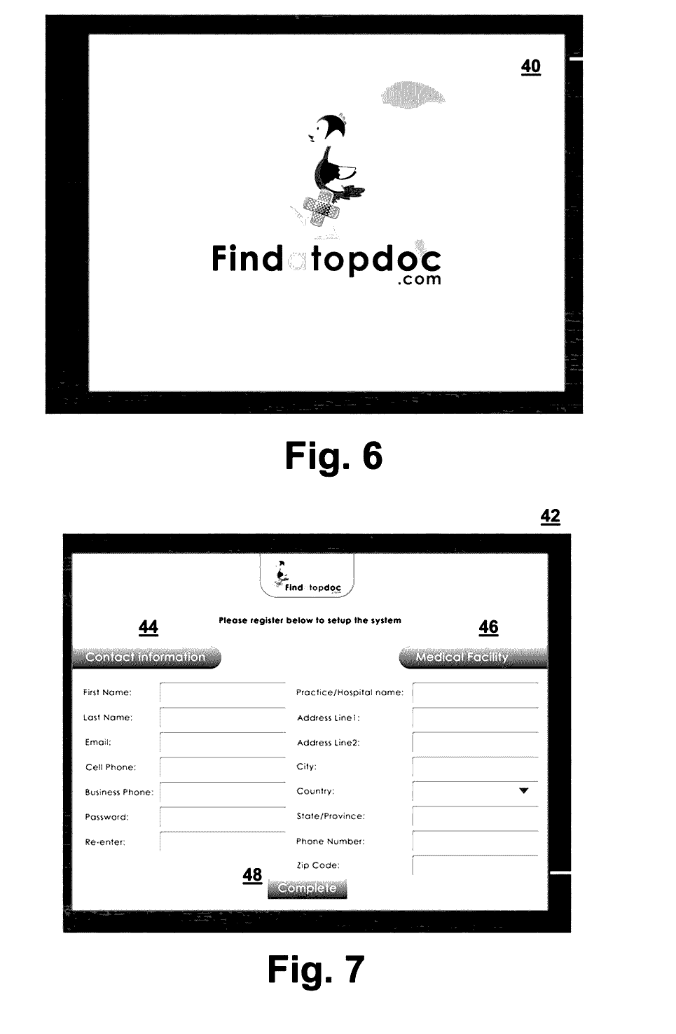

The FindaTopDoc website may present an Initial Website Page 40, shown in FIG. 6, to a prospective user of the FindaTopDoc App software and/or the FindaTopDoc relational database 90. The FindaTopDoc App and database may be setup and updated by an administrator of the FindaTopDoc system, or by an authorized user, using a System Setup Page 42, shown in FIG. 7.

A contact information section 44 provides one or more fields to enter: (1) first and last names; (2) an e-mail address; (3) a cell and/or a business phone number; and (4) a password. A medical facility section 46 provides one or more fields to enter: (1) the name of the medical facility; (2) address of the medical facility; and (3) a contact phone number for the medical facility.

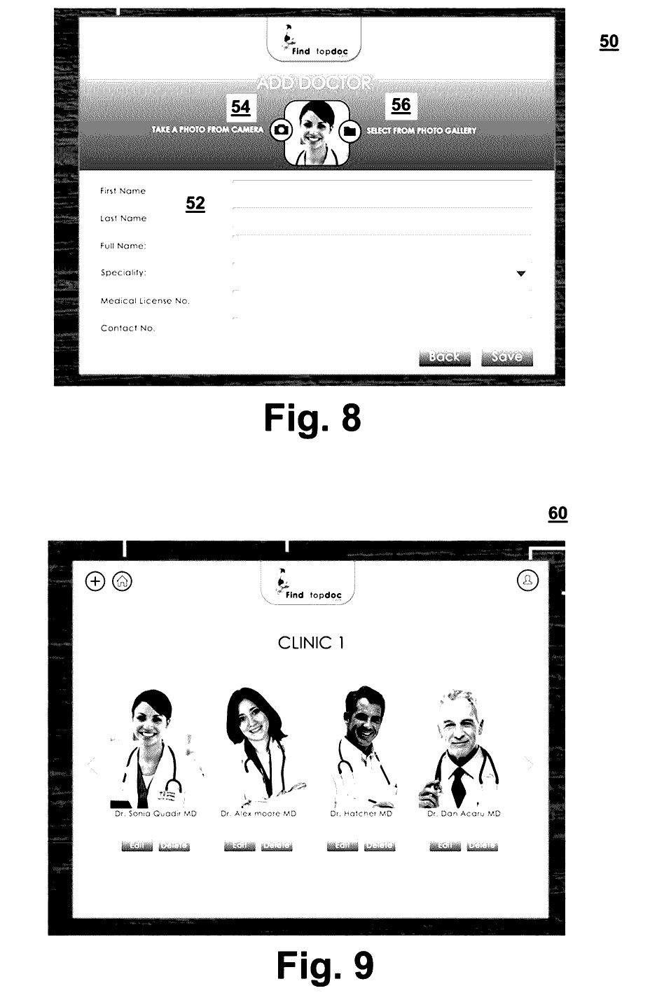

If a doctor is to be added to the roster of physicians listed for the medical facility, the user may access an Add Doctor Page 50, shown in FIG. 8. In the example shown, the Add Doctor Page 50 includes one or more fields for entering information about the doctor to be added to the FindaTopDoc relational database 90. The information to be provided for the additional doctor may include: (1) name of the doctor; (2) fields in which the doctor specializes; (3) the doctor's medical license; and (iv) contact information for the additional doctor. A photograph for the doctor may be obtained from an image obtained at the time of system setup by using a Photo Button 54, or a photograph may be downloaded from the FindaTopDoc relational database 90 by using a Photo Gallery Button 56.

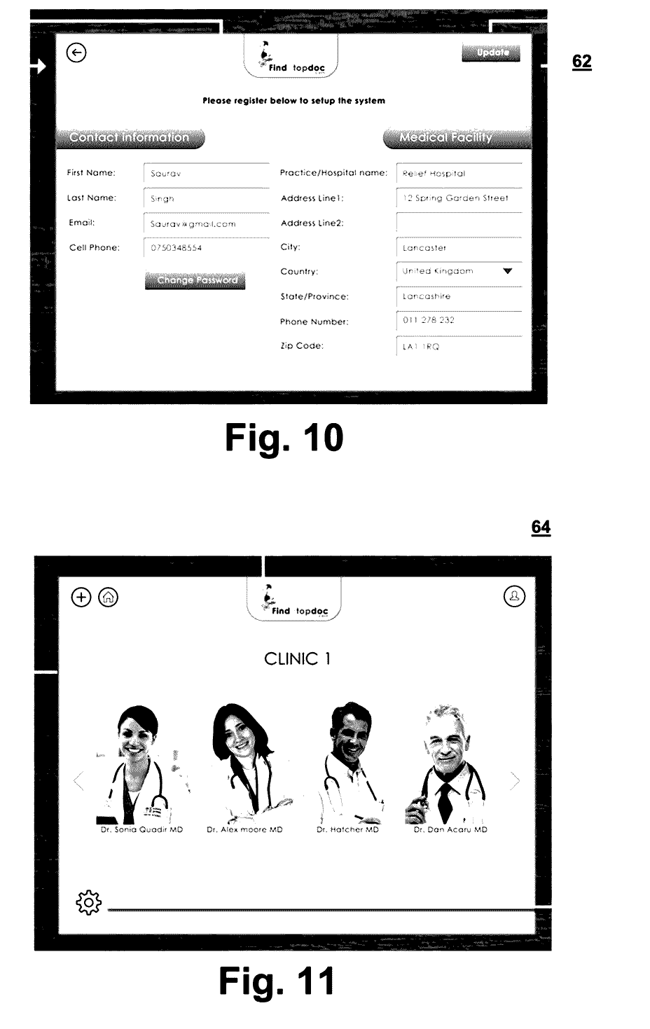

The user may access a Physician Roster Edit page 60, shown in FIG. 9, to review and edit the plurality of physicians listed in the FindaTopDoc relational database 90 for each medical facility. The editing process may require the user or administrator to verify that he is authorized to make such changes before he is given access to the Physician Roster Page 60. A System Setup Login page 62, shown in FIG. 10, may also allow the user to update physician information for physicians currently in the FindaTopDoc relational database 90. When any additions or editing has been completed, the user may return to a Physician Roster Page 64, shown in FIG. 11, to review the current roster of physicians.

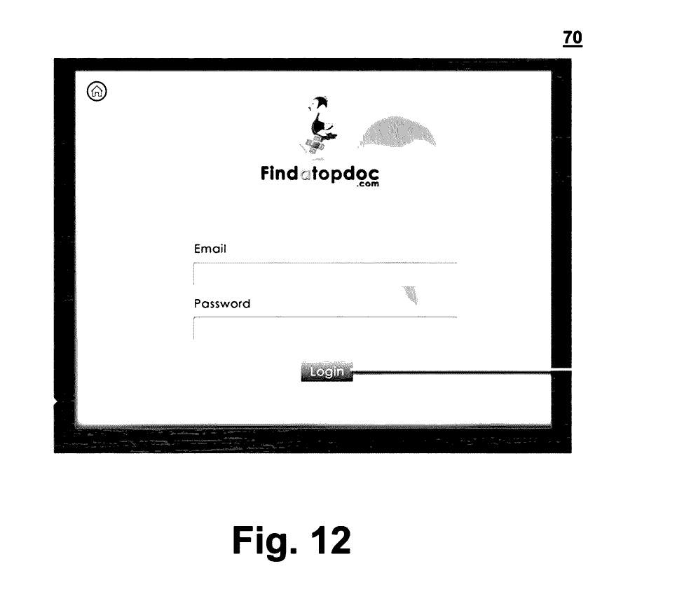

A prospective patient can wirelessly access the FindaTopDoc relational database 90 for physician information, using a personal computer or mobile communication device, by logging into the FindaTopDoc software via a Customer Login Page 70, shown in FIG. 12. After entering requested login information, such as e-mail and password, the prospective patient can review the information and comments available in the FindaTopDoc relational database 90.

With reference to FIG. 13, the information retrieval process 80 can be executed, at step 81, by visiting a web page, such as “FindaTopDoc.com” that has implemented FindaTopDoc reviews. The RSS feed and Javascript are consumed by placing a div in the HTML source with the attributes class, data-widget-id, data-widget-width, and data-widget-page-length specified. A Javascript file functions to continually update the div on the web (.html) pages for physician information, at step 83. Using an input that includes the physician ID, the Javascript file may make a request to the RSS feed for relevant and appropriate information, at step 85. The physician reviews may utilize Google-rich snippets for SEO optimization.

The RSS feed may be dynamically generated based on: (1) the physician ID; (2) the associated page(s), and (3) the items per page for rendering, at step 87. The RSS feed may be utilized by a Javascript file via Ajax requests to format the RSS feed for public consumption, and may add interactive elements such as pagination, the ability to show details, to report abuse or to mark an individual review helpful.

The requisite information may be stored in and/or obtained from the FindaTopDoc relational database 90. The data may be retrieved via SQL queries in a PHP script. The PHP script may dynamically generate XML data that adheres to the RSS 2.0 or later specification, based on (1) the physician ID; (2) the associated page(s); and (3) the items per page at step 89. It can be appreciated by one skilled in the art that this method may similarly be applied to a client-professional relationship for another type of professional service.

The FindaTopDoc relational database 90 thus functions to store “on site” physician review and comments, and tablet registration information. The data is collected from an app installed on mobile communication devices such as phones and tablets. The mobile communication devices interact with the database using a collection of web services that implement the CRUD design pattern.

In an exemplary embodiment, shown in FIG. 14, the office computer tablet 10 may be secured to an upright stand 94 mounted to a base 96 so as to establish a kiosk 92 that can be accessed in a physician's office or in the office of a professional service provider. As explained above, the computer tablet 10 may be in wired or wireless communication with the FindaTopDoc relational database 90 for a medical facility, or with an appropriate relational database for another type of professional facility.

The kiosk 92 may include a magazine rack 98 positioned at a convenient height, for example, for use by a waiting patient or client. In a conventional method of sharing office visit experiences with other patients, and providing feedback to the physician or other professional, the patient or client may use a paper form, or an online form, to provide information. Typically, this is done after some time has passed since the office visit with the doctor or other professional. Accordingly, the information thus provided may not be as accurate or thorough as information that is obtained shortly after the visit.

In comparison, the innovative system and method of using the kiosk 92, and of locating the kiosk 92 at the office or other professional facility, enables the patient or client to provide desired and valuable, accurate and thorough, information for disseminating and sharing, and conveniently provides feedback to the physician or other service professional.

It is to be understood that the description herein is only exemplary of the invention, and is intended to provide an overview for the understanding of the nature and character of the disclosed illumination systems. The accompanying drawings are included to provide a further understanding of various features and embodiments of the method and devices of the invention which, together with their description serve to explain the principles and operation of the invention.

What is claimed is:

1. A method for selecting a professional service provider, said method comprising the steps of:
visiting a web page that has implemented reviews of professional service providers;
updating a div on said web page for information related to said professional service providers;
making a request to an RSS feed for said information related to said professional service providers;
parsing said information related to said professional service providers; and
generating XML that adheres to an RSS specification.
